(19) United States
(12) Patent Application Publication
(10) Pub. No.: US 2020/0154689 A1
(43) Pub. Date: May 21, 2020

(54) Impact Resistant Fishing Rod Case

(71) Applicant: Edward Pierson, Forney, TX (US)

(72) Inventor: Edward Pierson, Forney, TX (US)

(21) Appl. No.: 16/193,408

(22) Filed: Nov. 16, 2018

(51) Int. Cl. A01K 97/08; B65D 43/16; B65D 55/02; B65D 85/30

(52) U.S. Cl. CPC A01K 97/08; B65D 85/30; B65D 55/02; B65D 43/164

(57) ABSTRACT

A fishing rod case composed of impact resistant material which covers the central portion and tip of the shaft of the fishing rod while leaving the handle and reel exposed. The case has two sections connected by a hinge and a closing mechanism which removably joins the two sections together when the case is in a closed position. The two sections each have a rod enclosing cutout which are joined to create an opening that encloses the rod when the case is closed. The circular opening is larger than the shaft of the rod, but smaller than the guides attached to the rod. Since the guides cannot pass through the opening created by joining the two rod enclosing cutouts the case is retained in place when it comes into contact with one of the guides attached to the shaft and is prevented from sliding off the rod.

### BACKGROUND OF THE INVENTION

### Field of the Invention

This invention relates to a cover for a fishing rod, and more particularly to a hinged cover that encloses the end of a fishing rod.

### Background of the Invention

When carrying a fishing rod, the hook is typically stored hooked into one of the eyelets of the fishing rod to prevent it from swinging freely and becoming tangled with the fishing line or snagging on nearby objects such as trees, clothing, or other fishing rods. However, the fishing hook can easily dislodged from the eyelet by movement or if the release button In addition, it is also necessary to ensure that impacts do not damage the rod or cause it to snap during transport. As the rod narrows towards the tip, it becomes more vulnerable to breakage with the tip of the rod being the easiest portion to snap off and the wider base being the hardest. For example, when the rod is stored in a car trunk or boat storage compartment for a fishing trip heavy objects such as boxes or coolers can easily break the rod during transport.

There are several existing protective devices which protect the hook from becoming tangled and which provide impact protection to prevent breakage of the rod. For example, U.S. Pat. No. 6,085,455A to Bracken and U.S. Pat. No. 2,767,502 to Reynolds disclose protective covers which are used to protect the hook when not in use and serves as a storage for additional hooks and lures. However, these devices only enclose a section of the central portion of the rod, leaving the brittle tip of the rod which is most vulnerable to impacts uncovered. In addition, the location of the container centrally on the rod means that if there is an impact to the case then the case itself may cause breakage of the rod by applying pressure at the points at which the protective case encloses the rod or by preventing the rod from flexing in response to the impact. Since the cases enclose only a small section of the central portion of the rod, impacts to the case will be transferred from the points where the rod passes through the case to the central portion of the rod which is vulnerable to breakage. For example, heavy objects such as coolers, suitcases, etc. may be dropped on the rod when stored in a boat compartment or car trunk, or the rod may collide with surrounding objects when being carried to the fishing spot. In either case, if the impact strikes the case the impact may be transferred to the rod at the points where the case is in contact with the rod, causing it to snap.

Likewise, U.S. Pat. No. 4,216,604 to Stark discloses a tip guard which encloses the tip of the rod in a hard material that provides impact protection and prevents tangling by storing the hook inside of the tip guard. While this is effective at preventing tangling and protects the most vulnerable part of the rod, it still leaves the rod vulnerable to breakage in its thinner central portion or at the point where the tip guard encloses the rod. As such, there is a need for a protective case which prevents tangles, protects the rod from impact, and does not expose the more vulnerable central portion and tip of the rod to transferred impacts at the point where the case encloses the rod.

### SUMMARY OF THE INVENTION

The protective case has a first section and a second section connected by a hinge. The two sections of the case have a rod enclosing cutout located at the bottom of the case. The cutout is large enough to enclose the shaft of the rod, but smaller in diameter than the eyelets of the rod. When the two sections of the cover are closed over the end of the fishing rod, the cutouts join around the shaft of the rod and enclose the tip and central portion of the rod shaft within the case.

It is an object of the invention to provide a protective case which protects the central section and tip of a fishing rod from impacts without exposing the end of the fishing rod to breakage via transfer of force at the point where the case encloses the rod.

It is another object of the invention to provide a case which can protect the end and central portion of fishing rods of varying lengths without adjustment.

It is another object of the invention to conserve weight by selectively protecting the portions of the rod most vulnerable to impacts from damage.

### BRIEF DESCRIPTION OF THE DRAWINGS

FIG. 1 is a view of a fishing rod case in an open position in accordance with an exemplary embodiment of the invention.

FIG. 2 is a view a fishing rod case in a closed position enclosing a smaller fishing rod in accordance with an exemplary embodiment of the invention.

FIG. 2A is a view a fishing rod case in a closed position enclosing a larger fishing rod in accordance with an exemplary embodiment of the invention.

FIG. 3 is a view of the end of a fishing rod case possessing a fishing line slot in a closed position in accordance with an exemplary embodiment of the invention.

### DETAILED DESCRIPTION OF THE PREFERRED EMBODIMENTS

A typical fishing rod has a handle for gripping the rod which extends up to the reel of the rod. The shaft of the rod extends from the handle at the point where the reel is attached. The shaft of the fishing rod has a butt end extending from the handle and terminates in a tip end. The shaft of the rod has guides or eyelets which typically take the form of metal loops through which the fishing line is threaded. The shaft is wider at the butt end and narrower at the tip end, with the thinner tip end being most vulnerable to breakage if there is an impact to the fishing rod.

In the preferred embodiment, the present invention is a fishing rod case made of impact resistant material which encloses a majority of the length of the shaft of the fishing rod, ideally leaving only a small portion of the butt end of the shaft located below the guide exposed to impact, while impacts transferred from the case to the rod will be directed to the base where it is widest and least likely to snap. In the preferred embodiment, the fishing rod case does not enclose the reel or portions of the shaft located below the reel in order to keep the case as lightweight as possible while allowing the case to fit multiple sizes of rod.

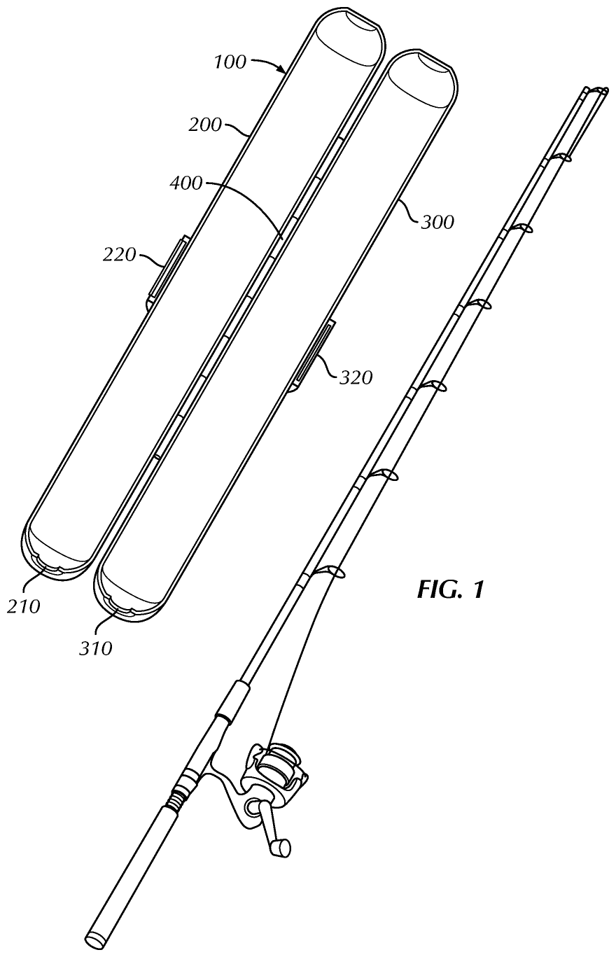

FIG. 1 is a view of a fishing rod case 100 in an open position in accordance with an exemplary embodiment of the invention. In the preferred embodiment the fishing rod case is divided into a first section 200 and a second section 300 connected by a hinge 400. The fishing rod case 100 may be placed in an open and closed position.

In the preferred embodiment, the fishing rod case 100 is placed in a closed position by joining together the latch 220 and a fastener 320 located on the edges of the first and second sections 200, 300 opposite the hinge 400. The latch 220 and fastener 320 place the fishing rod case 100 in a closed position.

In other embodiments, the closing mechanism may be a buckle, straps, velcro or another closing means which would be apparent to a person having ordinary skill in the art. In another embodiment, the two sections may be separate pieces which are joined together by a closing mechanism when the case is placed in a closed position.

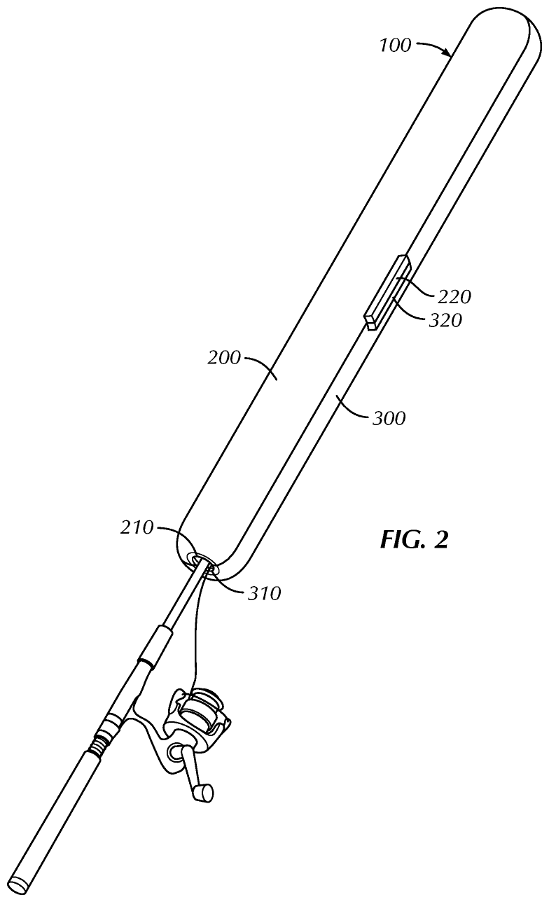

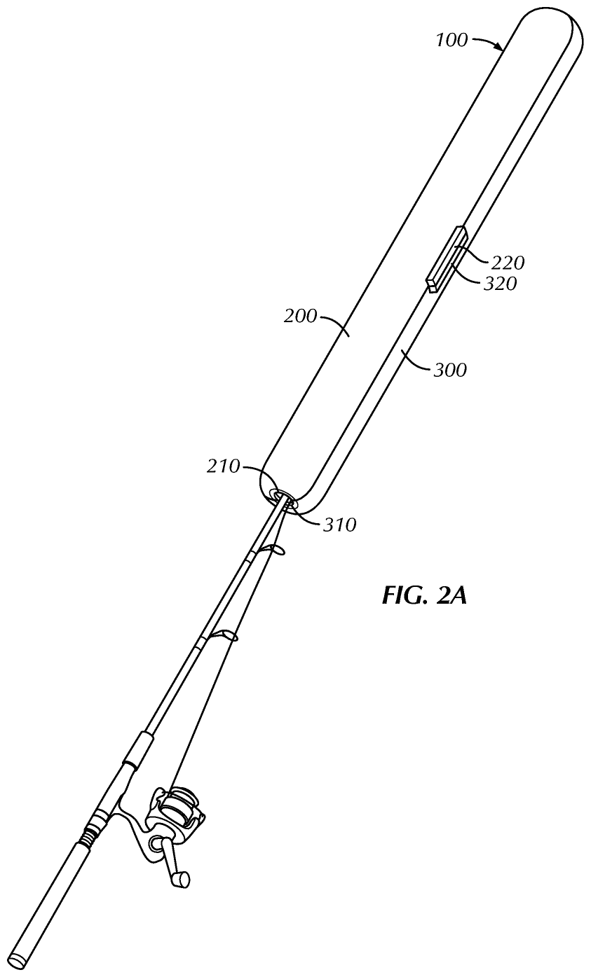

FIG. 2 is a view of a fishing rod case in an open position enclosing a smaller fishing rod in accordance with an exemplary embodiment of the invention. FIG. 2A is a view of a fishing rod case in a closed position enclosing a larger fishing rod in accordance with an exemplary embodiment of the invention.

In the preferred embodiment the first and second sections 200, 300 of the fishing rod case 100 each have a rode enclosing cutout 210, 310 at their bottom edges. In the preferred embodiment, the rod enclosing cutouts 210, 310 are semicircular and join to create a circular opening that encloses the rod when the case is closed. The circular opening is larger than the shaft of the rod, but smaller than the guides attached to the rod. Since the guides cannot pass through the opening created by joining the two rod enclosing cutouts 210, 310 the case is retained in place when it comes into contact with one of the guides attached to the shaft and is prevented from sliding off the rod. This allows the fishing rod case 100 to be used on rods of multiple sizes without adjusting the case.

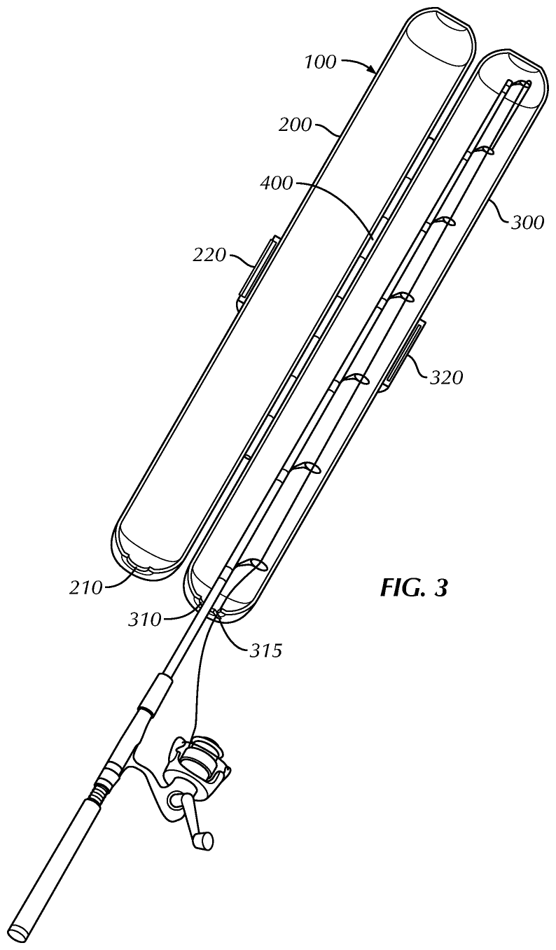

FIG. 3 shows the end of a fishing rod case possessing a fishing line slot in a closed position in accordance with an exemplary embodiment of the invention. In another embodiment, one or more of the rod enclosing cutouts 210, 310 may have a fishing line slot 315 or cutout which is thin enough that the guides of the fishing rod cannot pass through it, but wide enough to allow fishing line to pass through the slot. In one embodiment, the opening formed from the rod enclosing cutouts 210, 310 and the fishing line slot 315 when the fishing rod case 100 is in a closed position is substantially keyhole shaped. The fishing line is able to pass through the narrow portion of the keyhole shaped opening, but the guides of the fishing rod are too large to pass through. Threading the fishing line through the slot when closing the case allows the opening formed by the rod enclosing cutouts 210, 310 to be smaller in diameter while still accommodating the fishing line in the slot 315, enabling use of the fishing rod case with rods having smaller guides which might otherwise slip free through the opening. In another embodiment, rod enclosing cutouts 210, 310 are semicircular and the opening formed from the rod enclosing cutouts 210, 310 is circular, with both the rod and fishing line passing through the circular opening.

In another embodiment, the rod enclosing cutouts 210, 310 may be lined with a layer of soft impact absorbing material such as cloth in order to lessen the effect of impacts transferred from the case to the fishing rod at the point of enclosure by the case. In one embodiment, the fishing rod case 100 is oval or pill shaped in order to decrease the likelihood that it will catch on other objects and transfer impacts to the rod at the point of enclosure.

In the preferred embodiment, the fishing rod case is made of an impact resistant material. The case is composed of a hard, rigid material which resists impacts. In a preferred embodiment, the impact resistant material is a hard plastic material such as ABS (acrylonitrile butadiene styrene), polycarbonate plastic, or pDCPD (polydicyclopentadiene). In other embodiments the case may be composed of other impact resistant materials such metal, wood, rubber, a composite of plastic and a reinforcing material, composites of polymer based material mixed with other substances, or other impact resistant materials which would be known to a person of ordinary skill in the art.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally some elements illustrated in the singularity may actually be implemented in a plurality. Further, some element illustrated in the plurality could actually vary in count. Further, some elements illustrated in one form could actually vary in detail. Further yet, specific numerical data values (such as specific quantities, numbers, categories, etc.) or other specific information should be interpreted as illustrative for discussing exemplary embodiments. Such specific information is not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A fishing rod case composed of an impact resistant material, wherein the encloses the shaft and tip of a fishing rod, wherein the case comprises;
a first section; and
a second section, wherein the first section and second section are joined together on at one edge by a hinge, wherein the first and second section may be removably joined together to enclose a fishing rod via a closing mechanism, wherein the first and second section have rod enclosing cutouts which are joined to create an opening which closes around the shaft of the fishing rod, wherein the opening formed by the joining of the rod enclosing cutouts which close over the shaft of the fishing rod is configured to be wider in diameter than the length of the shaft of a fishing rod but smaller in diameter than the guides attached to the shaft of the fishing rod.

2. A fishing rod case as described in claim 1, wherein the edges of the rod enclosing cutouts that are in contact with the enclosed fishing rod when the case is in use are lined with an impact absorbent material.

3. A fishing rod case as described in claim 2 wherein the impact absorbent material is cloth.

4. A fishing rod case as described in claim 1 wherein the impact resistant material is plastic.

5. A fishing rod case as described in claim 1, wherein one or more of the rod enclosing cutouts has a slot configured to receive fishing line when the case is in a closed position.

6. A fishing rod case as described in claim 1, wherein the case is configured to enclose and provide impact protection to the tip and at least the majority of the shaft of the enclosed fishing rod but does not enclose the reel or handle of the enclosed fishing rod.

7. A fishing rod case composed of an impact resistant material, wherein the encloses the shaft and tip of a fishing rod, wherein the case comprises;
a first section; and
a second section, wherein the first section and second section are joined together on at one edge by a hinge, wherein the first and second section may be removably joined together to enclose a fishing rod via a closing mechanism, wherein the first and second section have rod enclosing cutouts which are joined to create an opening which closes around the shaft of the fishing rod, wherein the opening formed by the joining of the rod enclosing cutouts which close over the shaft of the fishing rod is between 0.5 and 3 cm in diameter.

8. A fishing rod case as described in claim 7, wherein one or more of the rod enclosing cutouts has a slot configured to receive fishing line when the case is in a closed position.

9. A fishing rod case as described in claim 7, wherein the case is designed to enclose and provide impact protection to the tip and at least the majority of the shaft of the enclosed fishing rod but does not enclose the reel or handle of the enclosed fishing rod.

10. A fishing rod case as described in claim 7, wherein the case is at least 3 feet in length.

11. A fishing rod case as described in claim 9, wherein the impact resistant material is plastic.
